(19) United States
(12) Patent Application Publication
(10) Pub. No.: US 2014/0024561 A1
(43) Pub. Date: Jan. 23, 2014

(54) Absorbent Polymers, and Related Methods of Making and Using the Same

(71) Applicant: B. Raghava Reddy, The Woodlands, TX (US)

(72) Inventor: B. Raghava Reddy, The Woodlands, TX (US)

(73) Assignee: Halliburton Energy Services, Inc., Houston, TX (US)

(21) Appl. No.: 13/552,045

(22) Filed: Jul. 18, 2012

(51) Int. Cl. C09K 8/88; E21B 33/13

(52) U.S. Cl. 507/117; 507/219; 507/229

(57) ABSTRACT

Compositions used in subterranean operations include absorbent polymers useful in controlling fluids within a subterranean formation; a method includes the steps of providing a treatment fluid having an absorbent polymer, the absorbent polymer including an aminoalcohol or polyamine-modified water-soluble polymer which includes a carboxylic acid derivative group, the method further includes placing the treatment fluid in at least a portion of a subterranean formation.

### BACKGROUND

The present invention relates to compositions used in subterranean operations. In particular, the present invention relates to methods of making and using degradable absorbent polymers with beneficial swollen deformability useful in controlling fluid flow within a subterranean formation.

Superabsorbent polymers (SAPs, or singular, SAP) are used in oilfield operations to control water production, divert injection fluids in enhanced oil recovery (EOR) operations, and to control loss circulation, such as in drilling or flooding operations. As used herein, the term “superabsorbent polymer” refers to a polymer capable of absorbing a substantially greater mass of liquid compared to its own mass. For example, a superabsorbent polymer may absorb from about 10 to about 500 times its own weight of water or more.

Typical absorbent or superabsorbent polymers used in the industry are crosslinked polyacrylamides that may be produced by chopping a dried gel obtained by copolymerizing acrylamide, acrylate and a crosslinker such as methylenebisacrylamide in water, followed by removal of water from the gel. The resulting irregularly shaped polymer particles, upon absorption of water, become swollen, and the swollen particles are typically expanded replicas of the shapes of the original particles. Upon applying pressure, however, due to the brittleness of the swollen gel particle, unexpectedly the particle may be more likely to break rather than deform by changing shape to accommodate the applied pressure. For example, when a fracture or a perforation is packed with such particles, and a hydrostatic pressure is applied, the particles do not press against each other by deforming to form a seal sufficiently competent to prevent flow of fluid through the swollen mass. This brittleness may be due to several factors, including the relatively high stiffness of the polymer resulting from the high degree of crosslink density throughout the polymer matrix, possibly augmented by additional surface crosslinking.

As described above, absorbent polymers may be useful in a variety of fluid flow control applications in subterranean operations. Many conventional fluid flow control compositions may be based on cross-linked gelling agents. A common problem encountered with these cross-linked gelling agents is that the resultant gel residue is often difficult to remove from the subterranean formation once the treatment has been completed. For example, in fracturing treatments, the cross-linked gels used may be difficult to completely clean up with conventional breakers, such as oxidizers or enzymes. Similarly, the gel residue may be difficult and time-consuming to remove from the subterranean formation. The gel residue, at some point in the completion operation, may be removed to restore the formation's permeability, preferably to at least its original level. If the formation permeability is not restored to its original level, production levels may be significantly reduced. This gel residue often requires long cleanup periods. Moreover, an effective cleanup usually involves fluid circulation to provide high driving force, which may allow diffusion of breaker molecules to take place to help dissolve the concentrated buildup of the gel residue. Such fluid circulation, however, may not be feasible. Additionally, in lower temperature wells (i.e., those below about 80° F.), it is often difficult to find an internal breaker for the viscosified treatment fluids that will break the gel residue effectively. Another conventional method of cleaning up gel residue is to add a spot of a strong acid (e.g., 10° A) to 15% hydrochloric acid) with coiled tubing, which is expensive and can result in hazardous conditions.

Still further challenges with conventional cross-linked gelling agent systems employed in fluid flow control is that high temperature formations (e.g., bottom hole temperatures of about 200° F. or greater) often require cross linking agents that are more permanently bonded to the polymer, and thus harder to break. Examples include transition metal cross linking agents. These more permanent cross linking agents can make cleanup of the resulting gel residue more difficult.

### SUMMARY OF THE INVENTION

The present invention relates to compositions used in subterranean operations. In particular, the present invention relates to methods of making and using degradable absorbent polymers with beneficial swollen deformability useful in controlling fluid flow within a subterranean formation.

In some embodiments, the present invention provides a method comprising the steps of providing a treatment fluid comprising an absorbent polymer, the absorbent polymer comprising an aminoalcohol- or polyamine-modified water-soluble polymer comprising a carboxylic acid derivative group, and placing the treatment fluid in at least a portion of a subterranean formation.

In other embodiments, the present invention provides a method comprising placing a treatment fluid for fluid loss control in a wellbore penetrating a subterranean formation, the treatment fluid comprising an absorbent polymer, the absorbent polymer comprising a water-soluble polymer comprising a carboxylic acid derivative that is heat-treated with an aminoalcohol or polyamine, and the method comprising degrading the absorbent polymer when fluid loss control is no longer needed.

In still other embodiments, the present invention provides a method comprising providing a water-soluble polymer comprising a carboxylic acid derivative in powder or bead form, coating the water-soluble polymer with an amino alcohol or polyamine, and heating the coated water-soluble polymer to provide an absorbent polymer, the polymer exhibiting deformability in a swollen state.

The features and advantages of the present invention will be readily apparent to those skilled in the art upon a reading of the description of the preferred embodiments that follows.

### BRIEF DESCRIPTION OF THE FIGURES

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a photograph showing the absorption of an aqueous solution containing a red dye by an inventive absorbent polymer, in accordance with embodiments disclosed herein.

FIG. 2 is a plot showing filtrate volume as a function of time for absorbent polymers of the invention compared to a commercial absorbent based on crosslinked polyacrylamide, POLYCRYSTAL™.

FIG. 3 is a plot showing swell factor as a function of time for absorbent polymers of the invention compared to a commercial absorbent based on crosslinked polyamide, POLYCRYSTAL™.

FIG. 4 is a Krumbein roundness and sphericity chart.

### DETAILED DESCRIPTION

The present invention relates to compositions used in subterranean operations. In particular, the present invention relates to methods of making and using degradable absorbent polymers with beneficial swollen deformability useful in controlling fluid flow within a subterranean formation.

Disclosed herein are methods of making and using absorbent polymers having swollen particle deformability and flexibility, controlled degradability, and production flexibility. In some embodiments, the absorbent polymers may be considered superabsorbent polymers (SAPs). In some embodiments, the elastic gel strength of the swollen particles may be reduced so that the particles can change shape upon application of pressure rather than breaking.

Advantageously, the absorbent polymer preparation methods disclosed herein are sufficiently flexible to allow modification to any carboxylic acid/carboxylic acid functional equivalent-containing polymer for numerous applications where the absorbent polymer may be subject to varied conditions, for example, such as in high temperature applications. Carboxylic acid functional equivalents include, without limitation, orthoesters, anhydrides, esters, amides, thioesters, thioamides, and the like. Additionally, in some embodiments, the absorbent polymers disclosed herein may be degraded after their intended use. For example, in multi-stage fracturing operations, the absorbent polymers disclosed herein may be used for diverting fracturing fluids, followed by degradation of the absorbent polymer before the well is put on production. Absorbent polymers disclosed herein may provide a superior alternative to conventional gelling agents employed for the same purpose due to the ease of controlled degradability.

Without being bound by theory, the superabsorbency and deformability/flexibility of the absorbent polymers disclosed herein may arise due to selective surface-crosslinking of solid polymer particles without causing crosslinking of the inner polymer matrix. Thus, such absorbent polymers may have uncrosslinked particle cores. As disclosed herein, access to such surface modified polymers may be achieved by selectively treating the surface of uncrosslinked solid polymer particles. For example, solid polymers in the form of powders or beads containing carboxylic acid derivative groups, such as acrylamides or other amide containing monomers that are otherwise soluble in water, may be coated with aminoalcohols, and heat treated to obtain absorbent polymers. This preparation method may be applied to a variety of polymers. In some embodiments, the polymer surface modification may be achieved by hot rolling coated powders at elevated temperatures, and using the product as is, without further purification or processing.

The resultant absorbent polymer product may be highly flexible when the particle is swollen and may be degradable under conditions of high temperature and/or high pH. The absorbent polymers disclosed herein may provide good fluid loss control when applied to a sand-pack bed. In some embodiments, the swollen absorbent polymer particles may be spherical without any applied load, and reversibly deform to oval to near flat-shapes under load. At high excess loads, it has been observed that some absorbent polymers disclosed herein may “pop” releasing their liquid contents, behaving in a sense, like liquid filled beads.

In some embodiments, the present invention provides methods comprising the steps of providing treatment fluids comprising absorbent polymers, the absorbent polymers comprising an aminoalcohol- or polyamine-modified water-soluble polymer comprising a carboxylic acid derivative group (i.e., water-soluble polymers comprising carboxylic acid derivative functional groups that have been heat-treated in solid state with aminoalcohols or polyamines), the methods further comprising placing the treatment fluids in at least a portion of a subterranean formation. As used herein, “absorbent” and “superabsorbent” are used interchangeably.

Methods of the invention employ treatment fluids that may be used as part of any subterranean operation. Such operations include, but are not limited to, drilling operations, lost circulation operations, stimulation operations, sand control operations, completion operations, acidizing operations, scale inhibiting operations, water-blocking operations, clay stabilizer operations, fracturing operations, frac-packing operations, gravel packing operations, wellbore strengthening operations, enhanced oil recovery operations, fluid diverting operations, and sag control operations. The methods and compositions of the present invention may be used in full-scale operations or pills. As used herein, a “pill” is a type of relatively small volume of specially prepared treatment fluid placed or circulated in the wellbore. In some embodiments, treatment fluids comprising absorbent polymers employed in methods of the invention may perform the function of controlling flow of formation fluids, controlling the treatment fluid itself, controlling other treatment fluids, and combinations thereof.

Treatment fluids of the invention may be aqueous-based, oil-based, or combinations thereof. Thus, suitable base fluids in treatment fluids of the invention, for use in conjunction with various methods may include, but are not limited to, oil-based fluids, aqueous-based fluids, aqueous-miscible fluids, water-in-oil emulsions, or oil-in-water emulsions.

Aqueous base fluids suitable for use in the treatment fluids of the present invention may comprise fresh water, saltwater (e.g., water containing one or more salts dissolved therein), brine (e.g., saturated salt water), seawater, or combinations thereof. Generally, the water may be from any source, provided that it does not contain components that might adversely affect the stability and/or performance of the treatment fluids of the present invention. In certain embodiments, the density of the aqueous base fluid can be adjusted, among other purposes, to provide additional particulate transport and suspension in the treatment fluids used in the methods of the present invention. In certain embodiments, the pH of the aqueous base fluid may be adjusted (e.g., by a buffer or other pH adjusting agent), among other purposes, to activate a cross-linking agent and/or to reduce the viscosity of the first treatment fluid (e.g., activate a breaker, deactivate a crosslinking agent) and/or to control the rate of degradation of the absorbent polymer itself. In these embodiments, the pH may be adjusted to a specific level, which may depend on, among other factors, the types of gelling agents, acids, and other additives included in the treatment fluid. One of ordinary skill in the art, with the benefit of this disclosure, will recognize when such density and/or pH adjustments are appropriate.

Suitable oil-based fluids may include alkanes, olefins, aromatic organic compounds, cyclic alkanes, paraffins, diesel fluids, mineral oils, desulfurized hydrogenated kerosenes, and any combination thereof. Suitable aqueous-based fluids may include fresh water, saltwater (e.g., water containing one or more salts dissolved therein), brine (e.g., saturated salt water), seawater, and any combination thereof. Suitable aqueous-miscible fluids may include, but not be limited to, alcohols, e.g., methanol, ethanol, n-propanol, isopropanol, n-butanol, sec-butanol, isobutanol, and t-butanol; glycerins; glycols, e.g., polyglycols, propylene glycol, and ethylene glycol; polyglycol amines; polyols; any derivative thereof; any in combination with salts, e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate; any in combination with an aqueous-based fluid, and any combination thereof. Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base treatment fluid, where the amount may range from any lower limit to any upper limit and encompass any subset therebetween. Examples of suitable invert emulsions include those disclosed in U.S. Pat. No. 5,905,061, U.S. Pat. No. 5,977,031, and U.S. Pat. No. 6,828,279, each of which are incorporated herein by reference. It should be noted that for water-in-oil and oil-in-water emulsions, any mixture of the above may be used including the water being and/or comprising an aqueous-miscible fluid.

Examples of suitable continuous mediums may include, but are not necessarily limited to, aqueous-based fluids, alcohols, glycerin, glycols, polyglycol amines, polyols, and any derivative thereof. Additionally, in some embodiments, the continuous medium may comprise a fluid selected from the group consisting of methanol, ethanol, n-propanol, isopropanol, n-butanol, sec-butanol, isobutanol, t-butanol, a mixture of methanol, ethanol, n-propanol, isopropanol, n-butanol, sec-butanol, isobutanol, or t-butanol and water, a mixture of ammonium sulfate, sodium sulfate, or potassium sulfate and water, a mixture of sodium chloride, potassium chloride, or calcium chloride and water, and combinations thereof. Optionally, the continuous medium comprises a fluid selected from the group consisting of ethanol, a mixture of t-butanol and water, and a mixture of ammonium sulfate and water. Mixtures of these may be suitable as well. Examples of suitable aqueous-based fluids may include, but are not necessarily limited to, fresh water, sea water, salt water, and brines (e.g., saturated salt waters). Examples of suitable brines may include, but are not necessarily limited to, heavy brines, monovalent brines, divalent brines, and trivalent brines that comprise a soluble salt like sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, potassium carbonate, any combination thereof, and any derivative thereof. Examples of suitable alcohols may include, but are not necessarily limited to, methanol, ethanol, propanol, iso-propanol, butanol, tert-butanol, and the like. Examples of suitable glycols may include, but are not necessarily limited to, polyglycols, propylene glycol, ethylene glycol, and the like.

In some embodiments, the treatment fluids for use in conjunction with the present invention may be foamed. In some embodiments, treatment fluids for use in conjunction with the present invention may comprise an aqueous base fluid, a gas, and a foaming agent.

Suitable gases for use in conjunction with the present invention may include, but are not limited to, nitrogen, carbon dioxide, air, methane, helium, argon, and any combination thereof. One skilled in the art, with the benefit of this disclosure, should understand the benefit of each gas. By way of nonlimiting example, carbon dioxide foams may have deeper well capability than nitrogen foams because carbon dioxide emulsions have greater density than nitrogen gas foams so that the surface pumping pressure required to reach a corresponding depth is lower with carbon dioxide than with nitrogen. Moreover, the higher density may impart greater proppant transport capability, up to about 12 lb of proppant per gal of fracture fluid.

In some embodiments, the quality of the foamed treatment fluid downhole may range from a lower limit of about 5%, 10%, 25%, 40%, 50%, 60%, or 70% gas volume to an upper limit of about 99%, 95%, 90%, 80%, 75%, 60%, or 50% gas volume, and wherein the quality of the foamed treatment fluid may range from any lower limit to any upper limit and encompass any subset therebetween. Most preferably, the foamed treatment fluid may have a foam quality from about 85% to about 99%, or about 95% to about 98%.

Suitable foaming agents for use in conjunction with the present invention may include, but are not limited to, cationic foaming agents, anionic foaming agents, amphoteric, zwitterionic foaming agents, nonionic foaming agents, or any combination thereof. Nonlimiting examples of suitable foaming agents may include, but are not limited to, surfactants like betaines, sulfated or sulfonated alkoxylates, alkyl quarternary amines, alkoxylated linear alcohols, alkyl sulfonates, alkyl aryl sulfonates, C10-C20 alkyldiphenyl ether sulfonates, polyethylene glycols, ethers of alkylated phenol, sodium dodecylsulfate, alpha olefin sulfonates such as sodium dodecane sulfonate, trimethyl hexadecyl ammonium bromide, and the like, any derivative thereof, or any combination thereof. Foaming agents may be included in foamed treatment fluids at concentrations ranging typically from about 0.05% to about 2% of the liquid component by weight (e.g., from about 0.5 to about 20 gallons per 1000 gallons of liquid).

A suitable oleaginous continuous phase for use in the present invention includes any oleaginous continuous phase fluid suitable for use in subterranean operations. By way of nonlimiting example, an oleaginous continuous phase may include an alkane, an olefin, an aromatic organic compound, a cyclic alkane, a paraffin, a diesel fluid, a mineral oil, a desulfurized hydrogenated kerosene, and any combination thereof. In some embodiments, the base treatment fluid may include an invert emulsion with an oleaginous continuous phase and an aqueous discontinuous phase. Suitable invert emulsions may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base treatment fluid, where the amount may range from any lower limit to any upper limit and encompass any subset there between.

Treatment fluids of the invention may further comprise weighting agents, viscosifiers, emulsifiers, proppants, pH modifying agents, cementing compositions, lost circulation materials, corrosion inhibitors, other subterranean treatment fluid additives, and the like, depending on the function of the treatment fluid.

In some embodiments, absorbent polymers employed in methods of the present invention comprise water-soluble polymers comprising carboxylic acid derivative functional groups. As used herein “carboxylic acid derivative functional groups,” refers to any of esters, anhydrides, amides, thioamides, thioesters, amidines, carboxamidines, carbamates, ureas, and any of which may be optionally substituted and any of which may be used in any combination. In some such embodiments, the carboxylic acid derivative functional groups are amides, such as polyacrylamides or polyvinylpyrrolidones. Polyacrylamides may comprise comonomers such as acrylate, methacrylate, or 2-acrylamide-2-methylpropane sulfonic acid (AMPS), for example. In some embodiments, the water-soluble polymer comprises an ester, such as polylactic acid (PLA) or methylated pectin. In some embodiments water-soluble polymers suitable for use with the present invention include semi-synthetic water-soluble polymers, synthetic water-soluble polymers, and mixtures thereof. Semi-synthetic water-soluble polymers are naturally-occurring water-soluble polymer derivatives. Synthetic water-soluble polymers are water-soluble polymers or their derivatives that are not naturally-occurring, that is, they are formed through chemical modification.

Both the semi-synthetic and synthetic water-soluble polymers are commercially available. Exemplary commercially-available semi-synthetic water-soluble polymers include, without limitation, cellulose ethers or esters, modified starches, starch derivatives, alginated, pectinates, natural gum derivatives, and mixtures thereof. Illustrative commercially-available synthetic water-soluble polymers include, without limitation, polymers, co-polymers, and polymer salts of acrylamide, acrylic acid, ethylene oxide, methacrylic acid, ethacrylic acid, esters or amides of acrylic, methacrylic, and ethacrylic acid, polyvinyl acetate, polyvinyl pyrrolidone, and copolymers thereof, as well as copolymers with other monomers, for example, substituted and unsubstituted two-to-eight carbon atom alpha-olefins such as ethylene, propylene, vinyl chloride, vinylidene chloride, vinyl fluoride, hexafluoropropylene and chlorotrifluoroethylene. Aromatic monomers such as styrene may also be employed.

In some embodiments, the water-soluble polymers are hydrophilic polymers, which may include polymer containing any array of heteroatoms that confer polarity to the polymer. Moreover, some such polymers may contain organic functional groups capable of supporting a formal charge, such as carboxylates, amines/ammonium groups, including mono alkyl ammonium, dialkyl ammonium, trialkylammonium, and tetraalkyl ammonium salts, sulfonates or alkyl sulfonates, phosphates or alkyl phosphates, or other charged functional groups. Examples of hydrophilic polymers may include, without limitation, polyvinylpyrrolidone, sodium carboxymethylcellulose, sodium alginate, guar, scleroglucan, diutan, welan, gellan, xanthan, and carrageenan.

Other suitable hydrophilic polymers may include homopolymers, copolymers, or terpolymers including, without limitation, polyacrylamides, polyvinylamines, poly(vinylamines/vinyl alcohols), alkyl acrylate polymers, and combinations thereof. Additional examples of alkyl acrylate polymers may include polydimethylaminoethyl methacrylate, polydimethylaminopropyl methacrylamide, poly(acrylamide-dimethylaminoethyl methacrylate), poly(methacrylic acid-dimethylaminoethyl methacrylate), poly(2-acrylamido-2-methyl propane sulfonic acid/dimethylaminoethyl methacrylate), poly(acrylamide-dimethylaminopropyl methacrylamide), poly(acrylic acid/dimethylaminopropyl methacrylamide), poly(methacrylic acid-dimethylaminopropyl methacrylamide), and combinations thereof.

In some embodiments, the water-soluble polymer may comprise a block copolymer. In some such embodiments, the block copolymer may be a diblock, triblock, tetrablock, or other multiblock copolymer. In some embodiments, the water-soluble polymer may comprise a graft copolymer. In some embodiments, the water-soluble polymer may be a periodic copolymer. In some embodiments, the water-soluble polymer may be an alternating copolymer. In some embodiments, the water-soluble polymer may be an interpolymer.

In some embodiments, the water-soluble polymer may be selected to be degradable when subject to various conditions that may be controlled by an operator. In some embodiments, the polymer may be selected to be self-degrading under the ambient conditions within the subterranean formation. In some embodiments, the water-soluble polymer may be selected to degrade to environmentally benign byproducts. Suitable examples of degradable polymers that may be used in accordance with the present invention include, but are not limited to, those described in the publication of Advances in Polymer Science, Vol. 157 entitled “Degradable Aliphatic Polyesters,” edited by A. C. Albertsson, pages 1-138. Specific examples include homopolymers, random, block, graft, and star- and hyper-branched aliphatic polyesters. Such suitable polymers may be prepared by polycondensation reactions, ring-opening polymerizations, free radical polymerizations, anionic polymerizations, carbocationic polymerizations, coordinative ring-opening polymerizations, as well as by any other suitable process.

Examples of suitable degradable polymers that may be used in conjunction with the methods of this invention include, but are not limited to, aliphatic polyesters; poly(lactides); poly(glycolides); poly(ε-caprolactones); poly(hydroxy ester ethers); poly(hydroxybutyrates); poly(anhydrides); polycarbonates; poly(orthoesters); poly(amino acids); poly(ethylene oxides); poly(phosphazenes); polyether esters, polyester amides, polyamides, and copolymers or blends of any of these degradable polymers, and derivatives of these degradable polymers. The term “copolymer” as used herein is not limited to the combination of two polymers, but includes any combination of polymers, e.g., terpolymers and the like.

As referred to herein, the term “derivative” is defined herein to include any compound that is made from one of the listed compounds, for example, by replacing one atom in the base compound with another atom or group of atoms. Of these suitable polymers, aliphatic polyesters such as poly(lactic acid), poly(anhydrides), poly(orthoesters), and poly(lactide)-co-poly(glycolide) copolymers may be beneficially employed, especially poly(lactic acid) and poly(orthoesters). Other degradable polymers that are subject to hydrolytic degradation also may be suitable. One's choice may depend on the particular application or use and the conditions involved. Other guidelines to consider include the water solubility of the degradation products that result, the time required for the requisite degree of degradation, and the desired result of the degradation, such as removal of the weighting agent.

Suitable aliphatic polyesters have the general formula of repeating units shown below:

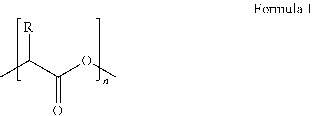

where n is an integer between 75 and 10,000 and R is selected from the group consisting of hydrogen, alkyl, aryl, alkylaryl, acetyl, heteroatoms, and mixtures thereof. In certain embodiments of the present invention wherein an aliphatic polyester is used, the aliphatic polyester may be poly(lactide). Poly(lactide) is synthesized either from lactic acid by a condensation reaction or, more commonly, by ring-opening polymerization of cyclic lactide monomer. Since both lactic acid and lactide may achieve the same repeating unit, the general term poly(lactic acid) as used herein is included in Formula I without any limitation as to how the polymer was made (e.g., from lactides, lactic acid, or oligomers), and without reference to the degree of polymerization or level of plasticization.

The lactide monomer exists generally in three different forms: two stereoisomers (L- and D-lactide) and racemic D,L-lactide (/meso-lactide). The oligomers of lactic acid and the oligomers of lactide are defined by the formula:

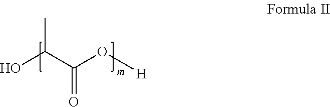

where m is an integer in the range of from greater than or equal to about 2 to greater than or equal to about 75. In certain embodiments, m may be an integer in the range of from greater than or equal to about 2 to greater than or equal to about 10.

The chirality of the lactide units provides a means to adjust, inter alia, degradation rates, as well as physical and mechanical properties. Poly(L-lactide), for instance, is a semicrystalline polymer with a relatively slow hydrolysis rate. This could be desirable in applications or uses of the present invention in which a slower degradation of the degradable material is desired. Poly(D,L-lactide) may be a more amorphous polymer with a resultant faster hydrolysis rate. This may be suitable for other applications or uses in which a more rapid degradation may be appropriate. The stereoisomers of lactic acid may be used individually, or may be combined in accordance with the present invention. Additionally, they may be copolymerized with, for example, glycolide or other monomers like E-caprolactone, 1,5-dioxepan-2-one, trimethylene carbonate, or other suitable monomers to obtain polymers with different properties or degradation times. Additionally, the lactic acid stereoisomers may be modified by blending high and low molecular weight polylactide or by blending polylactide with other polyesters, in embodiments wherein polylactide is used as the degradable material, certain preferred embodiments employ a mixture of the D and L stereoisomers, designed so as to provide a desired degradation time and/or rate. Examples of suitable sources of degradable material are poly(lactic acids) that are commercially available from NatureWorks® of Minnetonka, Minn., under the trade names “300 ID” and “4060D.”

Aliphatic polyesters useful in the present invention may be prepared by substantially any of the conventionally known manufacturing methods such as those described in U.S. Pat. Nos. 6,323,307; 5,216,050; 4,387,769; 3,912,692; and 2,703,316, the relevant disclosures of which are incorporated herein by reference.

Polyanhydrides are another type of degradable polymer that may be suitable for use in the present invention. Examples of suitable polyanhydrides include poly(adipic anhydride), poly(suberic anhydride), poly(sebacic anhydride), and poly(dodecanedioic anhydride). Other suitable examples include, but are not limited to, poly(maleic anhydride) and poly(benzoic anhydride).

The physical properties of degradable polymers may depend on several factors including, but not limited to, the composition of the repeat units, flexibility of the chain, presence of polar groups, molecular mass, degree of branching, crystallinity, and orientation. For example, short chain branches may reduce the degree of crystallinity of polymers while long chain branches may lower the melt viscosity and may impart, inter alia, extensional viscosity with tension-stiffening behavior. The properties of the material utilized further may be tailored by blending, and copolymerizing it with another polymer, or by a change in the macromolecular architecture (e.g., hyper-branched polymers, star-shaped, or dendrimers, and the like). The properties of any such suitable degradable polymers (e.g., hydrophobicity, hydrophilicity, rate of degradation, and the like) may be tailored by introducing select functional groups along the polymer chains. For example, poly(phenyllactide) will degrade at about one-fifth of the rate of racemic poly(lactide) at a pH of 7.4 at 55° C. One of ordinary skill in the art, with the benefit of this disclosure, will be able to determine the appropriate functional groups to introduce to the polymer chains to achieve the desired physical properties of the degradable polymers.

In accordance with embodiments disclosed herein, any of the aforementioned water-soluble polymers may be heat-treated with aminoalcohols or polyamines to generate the absorbent polymers of the invention. In some embodiments, methods of the invention employ aminoalcohols comprising one selected from the group consisting of ethanolamine (EA), diethanolamine (DEA), triethanolamine (TEA), and combinations thereof. In some embodiments, methods of the invention employ polyamines that may be oligomeric ethyleneimines. In some such embodiments, the oligomeric ethyleneimine may be diethylene triamine, triethylene tetramine, tetraethylene pentamine or combinations thereof. Without being bound by theory, it is believed that the polyfunctional aminoalcohols or polyamines modify the surface of the solid water-soluble polymer particles via the carboxylic acid derivative functional group of the water-soluble polymers. Thus, there may be an amide exchange in some embodiments, or, in other embodiments, the formation of an amide from an ester, for example. In some embodiments, degradation of the resultant absorbent polymer may occur at high temperature, high pH, or combinations thereof. In some embodiments, an inherent degradability of the absorbent polymer may be controlled by the type and amounts of aminoalcohol or polyamine used for the thermal treatment. In some embodiments, temperature and/or duration at bottom hole temperatures may be used to control inherent degradability of the absorbent polymer.

In some embodiments, methods of the invention may employ absorbent polymers that swell upon absorption of a fluid and the swollen polymer may be readily deformable in the swollen state. In some such embodiments, the deformability may be sufficient for any subterranean operation where an absorbent polymer is indicated. As used herein, “deformable” means that the polymer will accommodate forces exerted upon it by taking on a new shape without being brittle and breaking. The shapes of swollen particles and their deformability may be described by using Krumbein shape factors used to describe proppant/grain roundedness and sphericity. As shown in FIG. 4, Krumbein shape factors are indicated by roundness on a scale of about 0.1 to about 0.9 on X-axis and sphericity on a scale of about 0.3 to about 0.9 on Y-axis with the highest numbers representing the most rounded and the most spherical particles. Proppant/grain roundness is a measure of the relative sharpness of the proppant/grain corners and proppant/grain sphericity is a measure of how closely the particle approaches sphericity. The Krumbein scale is a well known system in the art for describing particle shapes. The same scale can be used to describe the shapes of absorbent particles before and after fluid absorption. The shapes of conventional absorbent materials before fluid absorption may be described as having particle shapes having roundness/sphericity of about 0.1/0.3 to about 0.5/0.7 where the first number refers to roundness and the second number refers to sphericity. The swollen absorbent particles of the present invention may exhibit ratios from about 0.5/0.9 to about 0.9/0.9 irrespective of unswollen particle size or shape. Additionally, the deformability of the swollen particles of the present invention may range by 0.6 units on the spherecity scale, alternately by 0.4 units, alternately by 0.2 units. In an embodiment the deformability is reversible. In some embodiments, methods of the invention employ treatment fluids that may be drilling fluids. In some embodiments, methods of the invention employ treatment fluids that are used as a part of flooding operations. In some embodiments, methods of the invention employ treatment fluids in which the absorbent polymer functions to divert injection fluids during enhanced oil recovery operations. In some embodiments, methods of the invention employ treatment fluids in which the absorbent polymer functions to control water production. In some embodiments, methods of the invention employ treatment fluids in which the absorbent polymer functions as a fluid loss control agent. Any of the aforementioned operations may benefit from the absorbent properties of the absorbent polymers prepared by the methods disclosed herein. For example, absorbent polymers employed in various methods exemplified by these operations may be used, for example, to absorb formation fluids, such as water, or provide lost circulation control. The absorbent polymers employed in treatment fluids may be used in any other operation where the use of a swellable polymer may be indicated.

In drilling operations, drilling fluids containing absorbent polymers of the invention may benefit from reduced lost circulation, for example, to thief zones and other naturally occurring formation voids. In operation, drilling fluids may also infiltrate fractures created by excessive mud pressures, in addition to the pre-existing naturally occurring fractures or other openings within the formation. The absorbent polymers of the invention may be used to reduce fluid loss to these induced fractures. In addition to the absorbent polymers of the invention, the drilling fluids may further comprise emulsifiers, viscosifiers, weighting agents, and the like.

In some embodiments, methods of the invention employ treatment fluids that are used in flooding operations. Such flooding operations may include, without limitation, alkaline flooding, surfactant flooding, carbon dioxide flooding, steam flooding, in-situ combustion, gas injection, miscible flooding, microbial recovery, and polymer flooding, or any combination thereof. Any of the aforementioned flooding operations may be part of an enhanced oil recovery (EOR) operation.

In some embodiments, the present invention provides methods comprising placing treatment fluids for fluid loss control in wellbores penetrating subterranean formations, the treatment fluids comprise absorbent polymers, the absorbent polymers comprise water-soluble polymers comprising a carboxylic acid derivative that is heat-treated with aminoalcohols or polyamines, and the method further comprising degrading the absorbent polymer when fluid loss control is no longer needed. In some such embodiments, the methods employ water-soluble polymers comprising polyacrylamides or polyvinylpyrrolidones. In some embodiments, methods of the invention include degrading steps that may be accomplished at high temperature, high pH, or combinations thereof. As described above, the degradability of the absorbent polymer may also be a function of the selected aminoalcohol or polyamine. In the context of fluid loss control, degradability may be desired, for example, to allow access to a zone after drilling and cementing operations.

In some embodiments, absorbent polymers of the invention may be employed in cementing operations to improve efficacy of cementing the annulus between the well bore formation and the outer wall of a casing string in providing zonal isolation by employing absorbent polymers to prevent any water from entering the cement slurry during slurry placement better than conventional absorbent polymers. Such applications of absorbent polymers are described, for example, in U.S. Pat. No. 7,866,394, the relevant portions of which are incorporated herein by reference.

In some embodiments, well cementing methods may be performed in which an effective amount of one or more absorbent polymers of the invention is passed into a well bore in a preflush fluid such as a spacer fluid to reduce the influx of water into a cement slurry placed in the well bore. The presence of the absorbent polymers of the invention in the well bore serves to reduce the amount of water available to intermix with and dilute the cement slurry. The absorbent polymers of the invention may be placed into the well bore (for example, by adding to a spacer fluid) before the cement is passed into the well bore, concurrent with the passing of cement into the well bore (for example, by adding to the cement slurry), or after the cement is passed into the wellbore (for example, by using in squeeze cementing fluid).

In some embodiments, a primary cementing process may be carried out according to standard well cementing practices. The primary cementing process may include drilling a well bore down to a subterranean zone while circulating a drilling fluid through the well bore. A string of pipe, e.g., casing, is then run in the well bore. The drilling fluid is conditioned by circulating it downwardly through the interior of the pipe and upwardly through the annulus, which is located between the exterior of the pipe and the walls of the well bore. A carrier solution containing the absorbent polymers of the invention and a carrier fluid may then be displaced into the well bore, followed by displacing a cement slurry down through the pipe and up through the annulus in the well bore. Alternatively, the absorbent polymers of the invention may be combined with the cement slurry before concurrently displacing the swelling agent and the cement slurry into the well bore.

Any secondary cementing operations known in the art may also be performed using the absorbent polymers of the invention. For example, the cement sheath formed in the annulus as a result of primary cementing may contain permeable areas such as fractures, fissures, high permeability streaks, and/or annular voids through which water can flow. Channels of water may undesirably flow behind the casing. A cement squeezing technique may be employed to force cement into the permeable areas or void so as to seal or block the flow paths of water. Before performing cement squeezing, absorbent polymers of the invention may be displaced into the well bore via a carrier fluid, or alternatively, it may be combined with a cement slurry before the slurry is displaced into the well bore.

In some embodiments, the well bore may be monitored to detect and locate sources of water (such as fissures, cracks, fractures, streaks, flow channels, voids, and the like) that are suitable for plugging via introduction of the absorbent polymers of the invention. Any suitable means or methods for locating such sources of water may be used as known to those of skill in the art. For example, prior to injecting the absorbent polymers of the invention into the well bore, production logs such as temperature, fluid density, hydro, and flowmeter logs can be used singly or in combination to detect where water is flowing into the well bore. In addition, a magnetic resonance imaging log (MRIL) tool may be employed to analyze the well bore to determine where mobile water is present. Additional disclosure regarding MRIL tools can be found in U.S. Pat. No. 6,283,210, the relevant portions of which are incorporated by reference herein. Another diagnostic technique that may be utilized to locate flowing water in the well bore involves exciting oxygen molecules. In addition, a 360° depth of view tool may be used to examine the well bore for fractures, fissures, streaks, and voids.

Detecting the locations of flowing water in the well bore allows the absorbent polymers of the invention to be strategically placed in close proximity to the source of the flowing water. For example, the absorbent polymers of the invention may be placed in fractures, fissures, streaks, and voids found in the rock surrounding the well bore or in the cement sheath located in the annulus of the well bore. In some embodiments, the absorbent polymers of the invention do not immediately absorb water but begin to absorb water after there has been sufficient time to place it downhole in close proximity to the water source. While downhole, the absorbent polymers of the invention begin to absorb the water and swell into a gel mass that is substantially resistant to the flow of water therethrough, thereby effectively plugging the fractures, fissures, streaks, and voids through which the water could otherwise pass for at least a period of time. In the case of primary cementing, a reduction of water ingress into the wellbore may be sufficient to allow the cement to set up, harden, and thus become impervious to further degradation with a potential for flux or flow of water from formation sources.

Suitable absorbent polymers of the invention may exhibit superabsorbency rendering them suitable for use as absorbent products such as diapers, training pants, and feminine care products. Absorbent polymers of the invention are swellable crosslinked polymers, which have the ability to absorb and store many times their own weight of aqueous liquids. The absorbent polymers of the invention retain the liquid that they absorb and typically do not release the liquid, even under pressure.

In some embodiments, the present invention provides methods comprising providing water-soluble polymers comprising carboxylic acid derivatives in powder or bead form, coating the water-soluble polymers with aminoalcohols or polyamines, and heating the coated water-soluble polymer to provide an absorbent polymer, the absorbent polymer exhibiting deformability in a swollen state. In some such embodiments, the water-soluble polymers and the aminoalcohols or polyamines may be provided in a weight ratio in a range from about 1.0:0.05 to about 1.0:0.5, including any fractional ratio therebetween. In some embodiments, the weight ratio may be about 1.0:0.05, in other embodiments, about 1.0:0.1, in still further embodiments about 1.0:0.15, in yet other embodiments, about 1.0:0.20, about 1.0:0.25, about 1.0:0.30, about 1.0:0.35, about 1.0:0.40, about 1.0:0.45, and about 1.0:0.50, including any value in between.

Methods of the invention for preparing absorbent polymers for use in the methods described herein may include heating the water-soluble polymer in solid particle form with a neat aminoalcohol or polyamine. In some embodiments heating is performed in a range from about 60° C. to about 120° C. In some embodiments, heating is carried out in a relatively inert environment, such as under nitrogen or argon atmosphere. In some embodiments, heating is carried out in ambient atmosphere without the particular exclusion of oxygen. Heating may be carried out in a range from about 3 hours to about 24 hours.

In some embodiments, methods for preparing absorbent polymers of the invention may further include providing the water-soluble polymer in bead form. In some embodiments, methods for preparing absorbent polymers of the invention may further include providing the water-soluble polymer in sheet or fiber form. In some embodiments, methods for preparing polymers of the invention may include gentle agitating, rolling, or otherwise gently moving the water-soluble polymer so as to maintain its initial form of particle size or sheet/flakes, without excessive alteration of its starting geometrical parameters. In some embodiments, the surface coating agent may be spray coated on to solid polymer.

In some embodiments, the present invention provides an absorbent polymer made by the processes described herein. Exemplary products are given in the Examples below, but need not be limited to those. In some embodiments, the absorbent polymers of the invention comprise polyacrylamides surface treated, in accordance with methods of the invention, with ethanolamine, diethanolamine, triethanolamine, oligoethlyeneimines, and the like. In some embodiments, the present invention further provides a treatment fluid comprising any of the absorbent polymers disclosed herein. Such treatment fluids including any base fluid and other additives as suitable for its particular application.

To facilitate a better understanding of the present invention, the following examples of preferred or representative embodiments are given. In no way should the following examples be read to limit, or to define, the scope of the invention.

### EXAMPLES

### Example I

High molecular weight polyacrylamide bead products, MA-22 (available from Halliburton Energy Services, Inc., Duncan, Okla., Mol. Wt, 5 MM, % hydrolysis ˜<5%), ALCOMER® 120B (available from Ciba Specialty Chemicals Water Treatments Limited, Bradford, West Yorkshire, UK, Mol. Wt, 14 MM; % hydrolysis, 30%), ALCOMER®110RD (Mol. wt 11 MM, % hydrolysis ˜22%) and ALCOMER®60RD (Mol. Wt, 5 MM; % hydrolysis, 30%), MAGNAFLOC® 336 (available from Ciba Specialty Chemicals Water Treatments Limited, Bradford, West Yorkshire, UK, anionic flocculant polyacrylamide, mol. wt, 15-20 MM, % hydrolyis, 30%), Alcomer 80 (Mol. wt 9 MM, % hydrolysis, 0%) and ZETAG® 8140 (available from Ciba Specialty Chemicals Water Treatments Limited, Bradford, West Yorkshire, UK, Cationic, high mol. wt polyacrylamide) were surface coated with ethanolamine (EA), diethanolamine (DEA), triethanolamine (TEA) or diethylenetriamine (DETA) at polymer to alkanolamine weight ratio of 1:0.0.5 to 1:0.2 range and rolled in an oven at 80° C. for 20 hours. The resulting solid was used as is for swelling studies. For swelling, the polymer product was soaked in excess aqueous fluids (0.1 gram of polymer in 20 mL water, 2% sodium chloride solution, 0.5% NaOH solution or 2% HCl solution) for one day at room temperature (RT) or at 140° F. (140 F), and filtered. For comparison, swelling data with commercially available crosslinked polyacrylamide absorbent polymer of similar particle size (CRYSTALSEAL™ 1 mm, available from Halliburton Energy Services, Inc., Duncan, Okla.) in the same solvents is also provided. The weight of the swollen product after filtering out the excess solvent was measured and the swelling data is presented below in Table 1. An uncoated polyacrylamide sample (MA-22) heated to the same temperature for the same duration under identical conditions simply dissolved in water without forming any swollen particles.

TABLE 1

| | | Polymer | In Fresh | | In 2% | | In 0.5% | | In HCl | |
|---|---|---|---|---|---|---|---|---|---|---|
| | | to Amine | Water, g | | NaCl, g | | NaOH, g | | (2%), g | |
| Polymer | Amine | wt ratio | RT | 140° F. | RT | 140° F. | RT | 140° F. | RT | 140° F. |
| MA-22 | None | | 0 | — | — | — | — | — | — | — |
| MA-22 | EA | 1:0.12 | 2.0 | 6.5 | 1.1 | 6.2 | 6.8 | 10.1 | 0.7 | 0.4 |
| MA-22 | EA | 1:0.05 | 3.3 | 8.2 | 1.4 | 6.2 | 7.2 | 0 | — | — |
| MA-22 | DEA | 1:0.1 | 5.8 | 9.1 | 2.4 | 0 | 8.3 | 7.1 | — | — |
| MA-22 | DEA | 1:0.2 | 4.7 | 9.4 | — | — | — | — | 0.8 | 0.4 |
| MA-22 | TEA | 1:0.2 | 5.7 | 4.0 | | | | | 1.8 | 0.6 |
| MA-22 | DETA | 1:01 | 0.2 | — | 0.24 | — | — | — | — | — |
| ALCOMER ®120B | EA | 1:0.1 | 9.0 | — | 3.0 | — | — | — | — | — |
| ALCOMER ®110RD | EA | 1:0.1 | 2.5 | — | 1.2 | — | — | — | | — |
| ALCOMER ®60RD | EA | 1:0.1 | 5.6 | — | 1.8 | — | — | — | — | — |
| Magnafloc 336 | EA | 1:0.1 | 5.7 | — | 1.7 | — | — | — | — | — |
| ALCOMER ®80 | EA | 1:0.1 | 1.9 | 4.1 | 1.9 | 3.6 | — | — | — | — |
| ALCOMER ®80 | DEA | 1:0.2 | 3.5 | 4.8 | 2.7 | 2.9 | — | — | — | — |
| ZETAG ® 8140 | EA | 1:0.1 | 1.1 | — | — | — | — | — | — | — |

Comparative Example

| | | | | | | | | | | |
|---|---|---|---|---|---|---|---|---|---|---|
| CRYSTALSEAL ™1 mm | — | — | 12.5 | 11.8 | 3.2 | 2.9 | 5.1 | — | — | — |

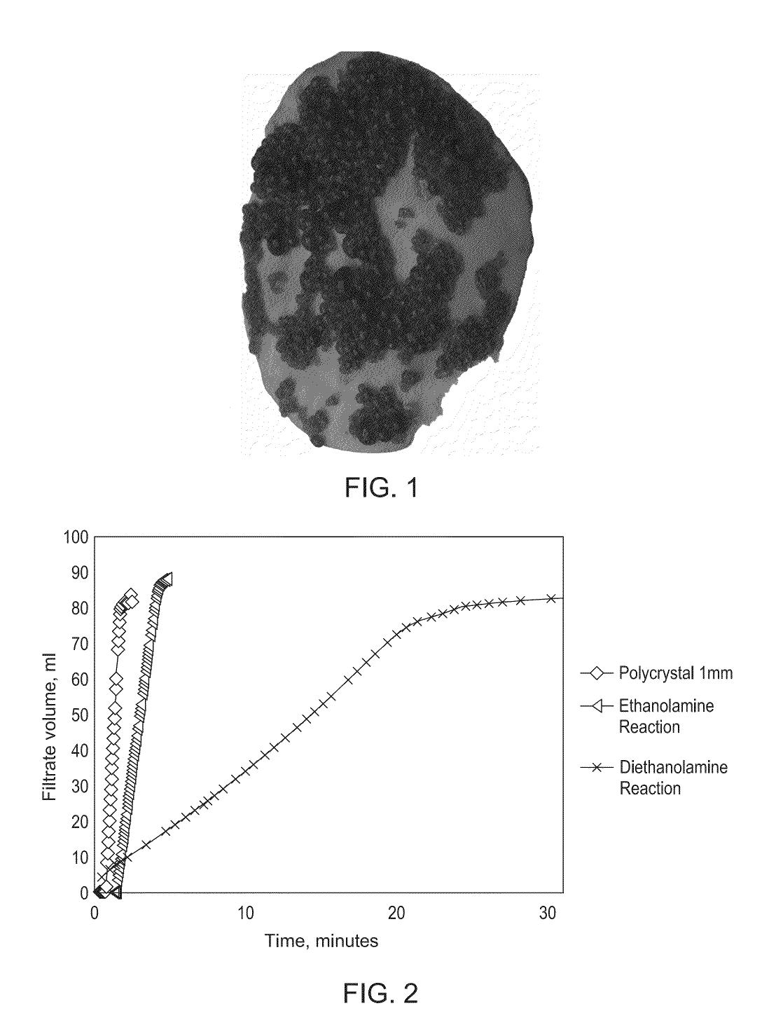

The results in Table 1 indicate that weight increases as high as 100 times (Swell Factor) the original weight upon swelling can be obtained with the modified polymers of the invention. Swell Factor is defined as the ratio of swollen polymer weight to dry polymer weight. The Krumbein Roundness/Sphericity rating for swollen particles of EA and DEA coated MA-22 and for commercial sample are estimated to be 0.9/0.9 and 0.5/0.7 respectively. FIG. 1 shows a photograph of DEA-treated MA-22 polymer (0.1 grams) swollen in a red dye solution in fresh water. Alkanolamines are particularly effective in forming superabsorbent products and are somewhat better than amine compounds containing no alcohol functional groups. The results also indicate that polyacrylamides with higher hydrolysis levels have higher swelling degree in fresh water. Alkanolamines containing secondary and tertiary nitrogens generally provide products with higher swell factors in fresh water.

As is evident from the comparison at the two temperatures, there is a substantial increase in swelling with increased temperature for the modified polymers of the invention, in sharp contrast to the commercial POLYCRYSTAL™ which appears insensitive to temperature increases. This property may be useful, for example, where swelling may be desirably triggered by altering temperature as controlled by an operator or where swelling may be desirable only in particular zones of a formation, leaving zones at lower temperature unimpeded by swollen polymer. The swelling behavioral differences between the modified polymers of the present invention and the commercially produced superabsorbents demonstrate that the inventive products are distinctly different structurally, and are not the same products produced by a different process.

Salt tolerance is also improved with modified polymers of the invention over a typical unmodified polyacrylamide, exemplified by POLYCRYSTAL™. This property is especially enhanced for modified polymers of the invention derived from polyacrylamides having low anionic content. Salt tolerance may be especially useful in the context of subterranean operations involving formation fluids or treatment fluids with significant salt content. High pH tolerance is also superior with alkanolamine reacted product, whereas low pH significantly inhibited the swelling for all polymers, including the commercial material.

### Example II

A homopolymer of vinylpyrrolidone (PVP) was also tested under conditions similar to those used for polyacrylamides in Example I. The results are shown in Table 2 below.

TABLE 2

| | | Polymer | In Fresh | | In 2% | |
|---|---|---|---|---|---|---|
| | | to Amine | Water, g | | NaCl, g | |
| Polymer | Amine | wt ratio | RT | 140° F. | RT | 140° F. |
| PVP K-90 | EA | 1:0.1 | 0.3 | — | — | — |
| | DEA | 1:0.07 | 0.25 | — | — | — |
| | DEA | 1:0.1 | 2.1 | — | 2.1 | — |
| | DEA | 1:0.17 | 1.6 | — | — | — |
| | TEA | 1:0.2 | 0.8 | — | — | — |
| | TEPA | 1:0.1 | 1.4 | — | — | — |
| | DETA | 1:0.1 | 0.5 | — | — | — |

Surprisingly, the modified PVP products provided swelling rates as high as about 21 times at room temperature indicating the generality of the polymer modification. There are no commercially available PVP based superabsorbent polymer (SAP) materials in the market. Moreover, in view of the non-toxicity and biodegradability of PVP, SAPs based on PVP are particularly useful.

### Example III

Thermally and hydrolytically stable acrylamide-based polymers containing small amounts of 2-acrylamido-2-methyl propane sulfonate (AMPS) and other stable monomers were also tested for their ability to form SAP materials using the procedures described in Example I. The base polymers included HE 100 (AMPS/acrylamide copolymer, and HE 300 (AMPS/vinylpyrrolidone/acrylamide terpolymer). The results are shown in Table 3 below.

TABLE 3

| | | Polymer | In Fresh | | In 2% | | In 0.5% | |
|---|---|---|---|---|---|---|---|---|
| | | to Amine | Water, g | | NaCl, g | | NaOH, g | |
| Polymer | Amine | wt ratio | RT | 140° F. | RT | 140 F. | RT | 140° F. |
| HE 100 | None | — | 0 | | 0 | | | |
| HE 100 | EA | 1:0.1 | 6.5 | 0 | 1.2 | 0 | | |
| HE 100 | DEA | 1:0.1 | 0.1 | 0 | 0 | 0 | | |
| HE 100 | DETA | 1:01 | Unswollen | | | | | |
| | | | solid | | | | | |
| HE 300 | DETA | 1:0.1 | 8.9 | 9.0 | 2.83 | 3.0 | 6.2 | 5.0 |
| HE 300 | TEPA | 1:0.1 | 3.4 | | | | | |

The results in Table 3 indicate that thermally stable SAPs can be obtained by modifying copolymers containing thermally stable monomers, such as AMPS with acrylamide as comonomer. Swelling rates as high as 90 times the original weight were achieved.

### Example IV

The performance of the materials of the invention as fluid loss agents is shown in FIG. 2. The experiment was performed in a high pressure filtration cell with a wire mesh screen/filter paper/silica gel bed (about 3 mm thick formed using 10 grams silica gel) bottom under a pressure of about 30 psi. The amount of dry polymer used was 0.2 grams. The polymer was separately swollen in a beaker overnight in 100 mL water at room temperature. The swollen polymer along with water was transferred to the filtration cell, and the amount of filtrate was measured as a function of time. The polymers used included the commercial POLYCRYSTAL™ 1 mm, MA-22 modified with ethanolamine at 1:0.12 ratio, and MA-22 modified with diethanolamine at 1:0.1 ratio. The results are plotted in FIG. 2.

The results in FIG. 2 show that commercial POLYCRYSTAL™ does not provide significant fluid loss control, whereas the flexible SAP products of the invention prepared, for example, with diethanolamine and polyacrylamide provided reasonable fluid loss control, that can be further improved by conventional means. A visual examination of the filter cake formed of the swollen absorbent particles on the silica gel bed indicated that while the roundness/sphericity for EA treated material and commercial material were similar to the values prior to forming the filter cake in the apparatus, the DEA particles appeared to be flatter with a roundness/sphericity rating of 0.9/0.5 indicating that the swollen particle deformability may have allowed for tighter packing of the deformable particles to form a filter cake with reduced permeability.

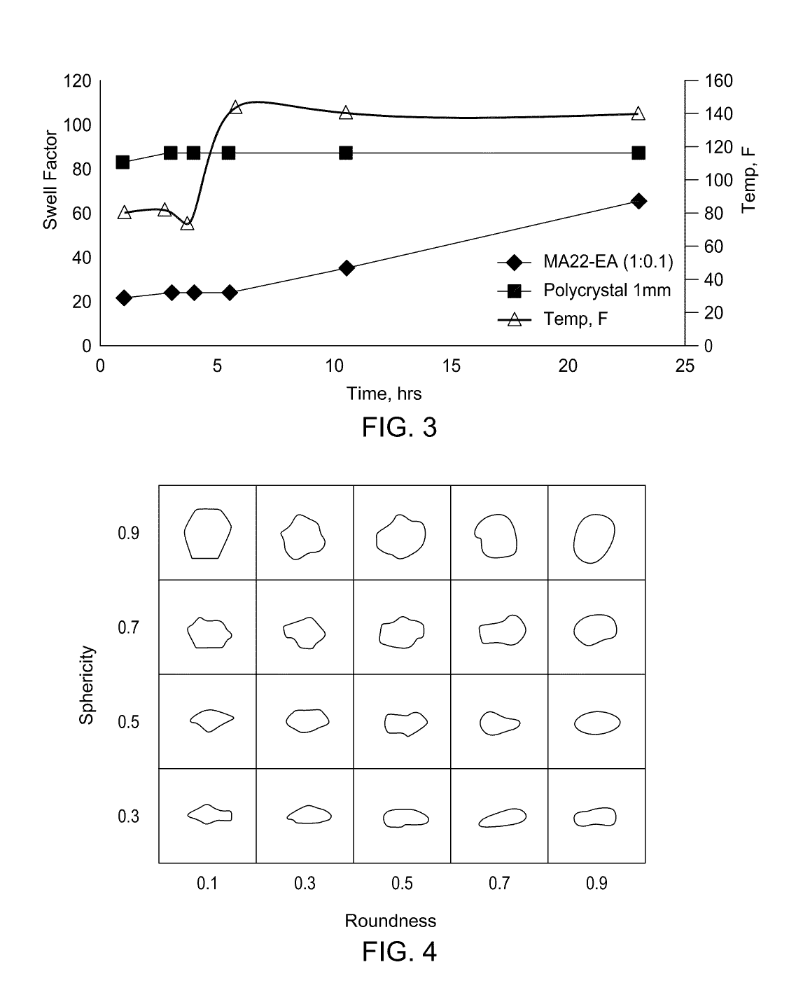

The rate of hydration of modified polyacrylamide is similar to that for commercial polyacrylamide based superabsorbent products of similar particle size at room temperature, as can be seen in FIG. 3. The swelling was complete in less than an hour. However, upon increasing the temperature from room temperature to 140° F., the SAP of the current invention increased swelling significantly (from 21 times to 65 times the original weight), whereas for the commercial material, there was no additional swelling with increase in temperature.

### Example V

The degradability of the SAP is a unique feature of the SAP of the present invention. The loss in weight of swollen solid polymer at elevated temperature as a function of time was measured by heating the swollen polymer in the presence of water and filtering the solid polymer at periodic intervals. The results in Table 4, show that the polymer dissolved with time as evident from decreased filtered polymer weight, increased viscosity of the filtrate, and increased difficulty in filtering the swollen polymer due to the adhesiveness of the released polymer. These experiments were performed with ethanolamine treated polyacrylamide, MA-22 at polymer to ethanolamine ratio of 1.0:0.1. The particle shapes noticeably changed upon filtration with continued heating at the test temperature and became flatter with easier deformability. The roundness values remained high at 0.9 but the sphericity values decreased indicating increased deformability.

TABLE 4

| | Filtered | Filtered |
|---|---|---|
| | Polymer | Polymer |
| | Residue wt | Residue wt |
| Time lapse, hrs | (g) @ 140° F. | (g) @ 190° F. |
| 24 | 6.1 | 2.0 |
| 48 | 7.5 | 0.4 |
| 84 | 4.9 | None |
| 7 days | 1.0 | None |

A special application for such behavior may be enhanced oil recovery (EOR) applications wherein an injection well is charged with a SAP of the present invention followed by injection of fresh water, which will slowly dissolve the released polymer and inject into the formation.

IR analysis of products, reactants, and commercial SAP materials did not indicate the presence of any functional groups other than amide and carboxylate groups in the final products. Particularly conspicuous by their absence are the ester functional groups which would have been expected in view of the alcohol groups in EA, DEA and TEA. However, if there is a minute degree of surface cross-linking by ester formation between carboxyl groups of the polymer and the alcohol groups of the alkanolamine, it might not be detectable unless special techniques are used. The observation that amines such as diethylene triamine (DETA) also provided SAPs in some cases, suggests that some surface cross-linking may take place through transamidation reactions. The role of thermal free radical generation on polymer molecules in the presence of alkanolamines followed by reactions with oxygen and radical coupling is also a possibility because when the reactions were repeated by replacing alkanolamine with benzoyl peroxide, solids with some swelling when placed in water were obtained. One observation that was made in many of the described reactions is the formation of ammonia gas, which may indicate either some hydrolysis or transamidation reactions. However, the latter reactions are not possible with triethanolamine which contains a tertiary nitrogen. Overall, it appears to be a complex reaction most likely taking place on the polymer particle surface.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising the steps of:
providing a treatment fluid comprising an absorbent polymer, the absorbent polymer comprising an aminoalcohol-modified or polyamine-modified water-soluble polymer comprising a carboxylic acid derivative group; and
placing the treatment fluid in at least a portion of a subterranean formation.

2. The method of claim 1, wherein the carboxylic acid derivative is an amide.

3. The method of claim 1, wherein the treatment fluid is a drilling fluid.

4. The method of claim 1, wherein the treatment fluid is used as part of a flooding operation.

5. The method of claim 1, wherein the absorbent polymer diverts an injection fluid during an enhanced oil recovery operation.

6. The method of claim 1, wherein the placing step comprises placing the treatment fluid in a portion of a formation where control of water production is indicated.

7. The method of claim 1, wherein the placing step comprises placing the treatment fluid in a portion of a formation where the use of a fluid loss control agent is indicated.

8. The method of claim 1, wherein the absorbent polymer swells upon absorption and is deformable in the swollen state.

9. The method of claim 1, further comprising degrading at least a portion of the absorbent polymer.

10. The method of claim 9, where the degrading occurs at high temperature, high pH, or combinations thereof.

11. The method of claim 8, wherein degrading of the absorbent polymer is controlled by the type of aminoalcohol or polyamine modification present in the absorbent polymer.

12. The method of claim 1, wherein the water-soluble polymer comprises a polyacrylamide.

13. The method of claim 1, wherein the water-soluble polymer comprises a polyvinylpyrrolidone.

14. The method of claim 1, wherein the aminoalcohol comprises one selected from the group consisting of ethanolamine, diethanolamine, triethanolamine, and combinations thereof.

15. The method of claim 1, wherein the polyamine comprises an oligomeric ethyleneimine.

16. The method of claim 15, wherein the oligomeric ethyleneimine comprises one selected from the group consisting of diethylene triamine, triethylene tetramine, tetraethylene pentamine or combinations thereof.

17. A method comprising:
placing a fluid loss control fluid in a wellbore penetrating a subterranean formation, the fluid loss control fluid comprising an absorbent polymer, the absorbent polymer comprising an aminoalcohol or polyamine-modified water-soluble polymer comprising a carboxylic acid derivative group; and
degrading at least a portion of the absorbent polymer when fluid loss control is no longer needed.

18. The method of claim 17, wherein the water-soluble polymer comprises a polyacrylamide or a polyvinylpyrrolidone.

19. The method of claim 17, wherein the degrading occurs at high temperature, high pH, or combinations thereof.

20. The method of claim 17, wherein the carboxylic acid derivative comprises an amide.

21. A method comprising:
providing a water-soluble polymer comprising a carboxylic acid derivative in powder or bead form;
coating the water-soluble polymer with an amino alcohol or polyamine; and
heating the coated water-soluble polymer to provide an absorbent polymer, the absorbent polymer exhibiting deformability in a swollen state.

22. The method of claim 21, wherein the water-soluble polymer and the aminoalcohol or polyamine are provided in a weight ratio in a range from about 1.0:0.05 to about 1.0:0.5.

23. The method of claim 21, wherein heating is performed at about 60-100 C for about 3 to 24 hours.

24. An absorbent polymer made by the method of claim 21.

25. A treatment fluid comprising the absorbent polymer of claim 24.
